(19) United States
(12) Patent Application Publication
(10) Pub. No.: US 2008/0306652 A1
(43) Pub. Date: Dec. 11, 2008

(54) Method and Computer Program for Personalizing Adjustable Functions in a Vehicle

(75) Inventors: Metta Boger, Stuttgart (DE); Christian Heinrich, Esslingen (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 10/574,508

(22) PCT Filed: Sep. 3, 2004
(86) PCT No.: PCT/EP2004/009831

§ 371 Date: Aug. 28, 2008

(30) Foreign Application Priority Data
Oct. 1, 2003 (DE) 10345746.1

(51) Int. Cl. B60R 16/02

(52) U.S. Cl. 701/36; 340/438

(57) ABSTRACT

The invention relates to a method and a computer program and a data carrier with this computer program for personalizing adjustable functions in a vehicle. The method provides that first a user profile in the form of stored, person-related settings and/or data of the functions for a current user of the vehicle is activated. To this extent, this method is basically known from the prior art. In order to restrict the access rights of other users to the user profile of the current user, the invention provides a configuration step, in the scope of which the current user can define which other user he would like to permit to access his person-related settings and/or data of functions within a previously defined group of functions. The access is respectively configured in a standardized way for all the functions within the group. The functions within a group are at least similar in terms of their requirement for personalization and/or their requirement for confidentiality.

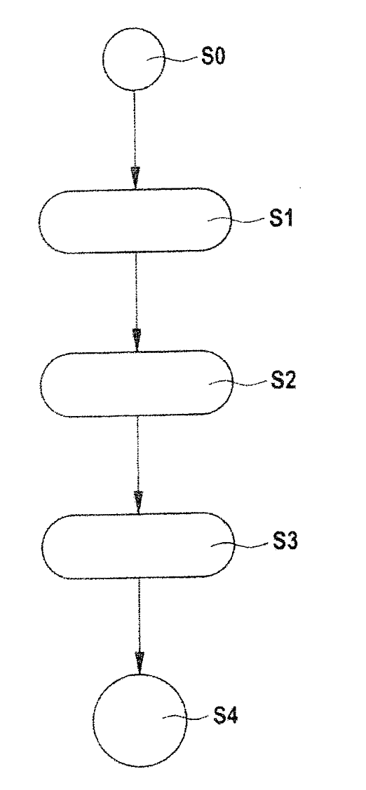

This application is a 371(c) National Phase filing of International patent application Serial No. PCT/EP2004/009831, filed Sep. 3, 2004, which claims priority to German patent application Serial No. 103 45 746.1, filed Oct. 1, 2003, the disclosures of which are hereby incorporated by reference in their entirety.

### BACKGROUND AND SUMMARY OF THE INVENTION

The invention relates to a method, and a computer program and a computer program product, for personalizing adjustable functions in a vehicle, in particular in a motor vehicle.

German laid-open patent application DE 199 61 619 A1 discloses a system of the generic type, in which a multiplicity of personalizable functions in a motor vehicle are specified, including, for example, the position of the mirrors and/or seats, acoustic properties of an audio system, the brightness of the dashboard lighting system or individual restrictions on the use of the vehicle by certain persons at certain times, etc. Individual-related settings of these functions can be stored in the form of an individual user profile so that they can be called up again at a later time.

However, in addition to the settings of the functions as specified above by way of example, a user profile generally also contains data, for example in the form of telephone directory lists or address lists, or in the form of personal e-mails or short message system SMS messages. Both the settings and in particular the data of a user profile may be confidential; that is, the user does not desire that the settings and data of his personal user profile should necessarily be made available to any other user of the vehicle.

One object of the present invention, therefore, is to provide a method and computer program for personalizing adjustable functions in a vehicle, in which unauthorized access to a respectively currently activated user profile is prohibited.

This and other objects and advantages are achieved by the method and apparatus according to the invention, which provides for a user profile to be activated in the form of stored, person-related settings and/or data of the functions for a current user of the vehicle, and which includes a configuration step that provides for configuration of future access to groups of at least some of the functions of the currently activated user profile. The functions within a group are at least similar in terms of their requirement for personalization and/or confidentiality, in that the current user defines individually, for each of these groups, which other user he permits to access his personal settings and/or data of the functions in a respective group.

With the implementation of this configuration step according to the invention, the user can himself control who (that is, which other user) is allowed to access his personal settings and/or data in his user profile, and who is not allowed to do so. In this context, the access is advantageously defined on a group-specific basis; that is, it is defined in a uniform way for all the functions within a group.

The term “requirement for personalization” in the sense of the invention refers to the extent of the desire of a user for, for example as many as possible, personal settings.

In contrast, the term “requirement for confidentiality” refers to the measure of confidentiality which the user assigns to the respective individual functions. For example, he may allocate a higher degree of confidentiality to his personal telephone lists or address lists than to his personal seat setting.

Within the scope of the configuration step according to the invention, the conditions under which future access to the currently activated user profile is to be possible are generally defined. Advantageous embodiments of the method according to the invention therefore provide not only the conditions for future access to groups of functions as noted above, but also further definitions for access operations to parts of the user profile. These further configuration possibilities may be implemented individually (independently of one another), or in combination with one another.

At this point only the possibility of configuring such that the current user can reserve any desired proportion of the total available storage capacity for person-related data and/or settings for storing his user profile will be mentioned in particular. Such reservation within the scope of the configuration is basically equivalent to expressing a desire for a specific storage capacity. However, in itself it does not cause the desired storage capacity to be seized. That is, such reservation initially does not yet take away any storage space from any other user, which occurs only in a further, optional, step. The latter step, which provides for the data and/or settings of a currently non-activated user profile to be reduced or deleted by the current user can be carried out even if, as a result, settings and/or data in another user profile are deleted. The advantage of this configuration possibility is that the current user does not require a password to delete parts of the user profile of the other user. This configuration possibility therefore presumes the existence of a certain degree of trust between the users.

Further advantages of the invention will become evident from the description and from the drawing. Exemplary embodiments of the invention are illustrated in a simplified form in the drawing and will be explained in more detail in the following description. In the drawing:

### BRIEF DESCRIPTION OF THE DRAWING

The single FIGURE is a schematic illustration of the method according to the invention.

### DETAILED DESCRIPTION OF THE DRAWING

As noted previously, the method according to the invention is to personalize adjustable functions in a vehicle, in particular in a motor vehicle. Such functions may relate, on the one hand, to any adjustable devices such as a seat, a mirror or the engine of the vehicle, but also e-mail systems or navigation systems or programs.

Following a starting step S0, in a first step S1, the user profile of a current user of the vehicle is activated. The user profile is concerned with stored individual-related settings and/or data of the aforesaid functions. The term “settings” means here, for example the personalized mirror settings or seat settings which are related to the current user, the setting of the brightness of the dashboard lighting, setting of the acoustic properties in an audio system or the setting of preferred transmitters of the car radio etc. In contrast, the term “data” relates to personal telephone directory lists, address lists, e-mails or SMS messages of the user.

The user profile can be activated in essentially two different ways. First, the user profile of the current user can be activated automatically for the personalization process when a control device starts. This applies in particular if the current user is the same person as a default user whose user profile is activated automatically when the control device starts. Alternatively or additionally, if the current user is not identical to any user profile, the default user profile is activated. As an alternative to the user profile of the default user it is also possible for the user profile of the current user to be activated automatically when the control device starts; this is usually the case if the current user was also the user who was activated when the control device was last operated, and the control device was configured in such a way that the next time it starts it automatically activates the user who was activated last, instead of the default user.

If the current is not the default user or the user who last used the control device, the user profile of the current user is activated in two stages. The first stage is identical to the abovementioned starting of the control device for the personalization process and the associated activation of the user profile for the default user or the last user. In a subsequent second stage, the current user is registered in a manner that requires him to identify himself by giving an assigned or his name. The desired activation of the user profile for the current user then takes place subsequently only if this identification is checked successfully.

The activation of the user profile of the current user is preferably carried out in a standardized way for all the personalized operator control units in the vehicle. This means that the personalized settings and/or data of the current user can preferably be accessed from all the operator control units in the vehicle, provided that these access operations are not restricted by a specific configuration such as is described further below. However, with this configuration it is important that simultaneous changes to the user profile which are carried out from various operator control units in the vehicle are prohibited.

The user profile of the default user preferably remains set at those operator control units of the vehicle at which the current user profile is not activated.

Within the scope of the configuration step S2 according to the invention, it is possible to define not only the abovementioned conditions for a future access operation to the groups of functions of the vehicle, but also conditions for further access operations to the currently activated user profile. For example, it is thus possible to define whether the access to the user profile is to be permitted in future only after a password (preferably specified during the registration) is input. If so, the password can be defined or changed, if desired. Within the scope of the configuration step S2, those users to which future access to the currently activated user profile is to be permitted for the purpose of deleting it or for the purpose of changing the assignment of available storage capacity, can also be defined.

Furthermore, it is possible to define the time period during which, after the control device has been shut down, the user profile of the user who was active last is set automatically for the personalization process, and not the user profile of the default user, when this device restarts. It is also possible to define whether the current user is to be registered to activate his user profile by means of his name and/or his user number. If appropriate, his name is to be preset as a reference variable within the scope of the configuration step. Furthermore, restrictions on the access rights and operator control possibilities for the currently activated user profile can be defined for selected (for example, the rear) operator control units in the vehicle. If necessary, these restrictions may be different, that is, they may be defined individually for individual users. Furthermore, the current user can reserve any desired storage capacity within available 100% storage capacity for storing the individual-related data and/or settings of his user profile within the scope of the configuration step S2. Finally, within the scope of the method step S2 it is also possible to define whether in the future the user is to be identified by means of the vehicle key and/or the user's mobile telephone when the control device starts.

A current setting of the user profile of the current user (such as is made available when this user profile is activated) corresponds either to the original presetting that is performed in the manufacturing process or to a change to these settings which was last carried out by the current user. The presetting of the user profile which is carried out at the works may comprise, for example, the following definitions:

It is possible to define the presettings for the functions of the individual groups, and to provide that these presettings are assigned to the user profile of the default user so that they are available when the user profile of the default user is activated. Furthermore, it is possible to provide that no password is required to access the settings of the user profile, or to specify the conditions under which a password is not required. In addition, it can be provided that for registration the current user does not need to be identified either by means of his name or by means of his key; that the access rights and operator control possibilities for individual operator control units in the vehicle are not restricted and/or that the 100% of the storage capacity is assigned to the default user for personalization purposes.

This presetting/assignment of 100% of the total available storage capacity personalization purposes solely to the default user is acceptable only for as long as no other users are provided. As soon as even one further user wishes to participate in the described personalization concept, he of course requires a sufficient proportion of the available storage capacity to store his person-related settings and/or data. It must then be possible to change the presetting which is made for the storage capacity at the factory. For this purpose, the invention provides that without exception any user is given permission to reduce or even delete the data and/or settings of a currently non-activated user profile. This freedom which is given to each current user provides the advantage that the current user does not need to know the password of the other user, whose memory area he is intending to reduce, in order to correspondingly set up his own memory. Of course, such a procedure in the present case is possible only because sufficient trust is assumed to exist between all the users of the system so that it is not to be assumed that a user will also intentionally delete data and settings of another user. Instead, it is basically assumed that when assigning the storage capacities which are respectively required for them, the users will agree among themselves. Nevertheless, if the storage capacity for another user is, in particular, reduced in an undesired way, a warning message is advantageously output both to the currently activated user and preferably also to the other user.

The method described above is advantageously implemented in the form of a computer program with suitable program code. With such a solution it is conceivable that this computer program is stored, if appropriate together with other computer programs, on a computer readable data carrier, such as a diskette, compact disc, flash memory etc. The computer program which is stored on the data carrier or the program code which is stored there can then be sold as a product to a customer.

However, the computer program can also be transmitted and sold to a customer without using a data carrier over an electronic communications network, in particular the Internet.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-13. (canceled)

14. A method for personalizing adjustable functions in a vehicle, said method comprising:
activating a user profile in the form of stored, individual-related settings or data for implementing vehicle functions for a current user of the vehicle;
allocating vehicle functions into groups of vehicle functions which are at least similar in terms of their requirement for personalization or confidentiality; and
configuring future access to said groups of at least some of the functions of a currently activated user profile;
wherein the current user defines individually, for each of said groups, which other user he permits access to his individual-related settings or data of the functions in a respective group.

15. The method as claimed in claim 14, wherein if the current user is identical to a default user whose user profile is activated automatically when the control device starts, the user profile of the current user is activated automatically when a control device for the personalization starts.

16. The method as claimed in claim 14, wherein the activation of the user profile for the current user is triggered by the following, preceding steps:
starting a control device for the personalization process, wherein first the user profile for a default user is activated; and
if the current user is not identical to the default user, registering the current user in the form of an identification of his person by inputting a user number which represents him or his name.

17. The method as claimed in claim 15, wherein the user profile of the current user is activated in a standardized way for a multiplicity of operator control units.

18. The method as claimed in claim 17, wherein for operator control units in the vehicle with a user profile which is activated in the standardized way, simultaneous changes to the user profile are prohibited if they are performed simultaneously from various operator control units.

19. The method as claimed in claim 17, wherein the user profile of the default user continues to be set at those operator control units in the vehicle at which the current user profile is not activated.

20. Method according to claim 14, wherein the configuration of access to a currently activated user profile also comprises at least one of the following definitions:
whether future access is to be permitted after merely inputting a password which is specified when registering, and if so, definition or changing of said password;
users to which future access to the currently activated user profile is to be permitted in principle for the purpose of deleting said profile;
users who, within the scope of access to the current user profile, are to be permitted to change the assignment or the distribution of available storage capacity for at least individual users;
a time period after the control device has been shut down for the personalization process, during which time period the user profile of the user who was active last is set automatically, and rather than the user profile of the default user, when the control device restarts;
whether registration of the current user is to be made by using his name or by using his user number, and if so, specification of said name;
restrictions on access rights and operator control possibilities for the currently activated user profile for selected operator control units, in the vehicle, if necessary differently for individual users;
reservation of a storage capacity by the current user for the person-related data and/or settings of his user profile; and
definition of whether the user is to be identified thereafter by means of the vehicle key or the user's mobile telephone when the control device starts.

21. The method as claimed in claim 20, wherein the current setting of the user profile of the current user represents either an original presetting which is carried out at an assembly place for the vehicle or a change in the setting which was last carried out by the current user and is permissible within the scope of the configuration.

22. The method as claimed in claim 21, wherein presetting of the user profile which was carried out at the assembly place comprises at least one of the following:
a definition of settings for functions of the individual groups, and an assignment of these presettings to the user profile of the default user;
a provision that no password is necessary for access to the settings;
a provision that for registration, the current user need not be identified either by his name or by his key;
a provision that the access rights and operator control possibilities for individual operator control units in the vehicle are not restricted; and
a provisional that 100% of the storage capacity is assigned to the default user for personalization purposes.

23. The method as claimed in claim 14, further comprising:
reducing or deleting of the data or settings of a currently non-activated user profile.

24. The method as claimed in claim 23, wherein a warning message is output to the currently activated and/or the currently non-activated user.

25. A computer readable medium having a computer program encoded therein, said computer program containing the following steps for personalizing adjustable functions in a vehicle:
activating a user profile in the form of stored, individual-related settings or data for implementing vehicle functions for a current user of the vehicle;
allocating vehicle functions into groups of vehicle functions which are at least similar in terms of their requirement for personalization or confidentiality; and
configuring future access to said groups of at least some of the functions of a currently activated user profile;
wherein the current user defines individually, for each of said groups, which other user he permits access to his individual-related settings or data of the functions in a respective group.
